(19) United States
(12) Patent Application Publication
(10) Pub. No.: US 2017/0201791 A1
(43) Pub. Date: Jul. 13, 2017

(54) INTERACTIVE METHOD ON INTELLIGENT HOME APPLIANCE BASED ON SMART TV VIDEO SCENES AND THE SYSTEM THEREOF

(71) Applicant: SHENZHEN SKYWORTH-RGB ELECTRONIC CO., LTD, Shenzhen (CN)

(72) Inventor: Chunyuan FU, Shenzhen (CN)

(21) Appl. No.: 15/323,840

(22) PCT Filed: Nov. 6, 2015
(86) PCT No.: PCT/CN2015/093958

§ 371 Date: Jan. 4, 2017

(30) Foreign Application Priority Data
Aug. 28, 2015 (CN) 201510538524.0

(51) Int. Cl. H04N 21/436; H04L 12/28; H04N 21/426; H04N 21/4402; H04N 21/435

(52) U.S. Cl. CPC H04N 21/43615; H04N 21/440254; H04N 21/435; H04N 21/42684; H04L 12/2816; H04L 12/2827; H04N 21/43637

(57) ABSTRACT

The present invention discloses an interactive method on intelligent home appliance based on smart TV video scenes and the system thereof, the method includes: presetting a database to store a plurality of image features on different video scenes and an operation data on intelligent home appliance corresponding to different video scene types; obtaining a plurality of video data currently playing on the smart TV, and determining the current video scene type; based on the current video scene type, starting connection with the intelligent home appliances, and checking whether the connection between the smart TV and the intelligent home appliance is success or not; if the connection between the smart TV and the intelligent home appliance is detected to be successful, then the intelligent home appliances are controlled to perform the corresponding operations. The present invention may analyze the scene elements of the video contents playing on TV, and control various intelligent home appliances to automatically change the surrounding environment conditions of the user, thus may make the user immersive, and improve the interaction between the smart TV and intelligent home appliances, which has facilitated a user to watch a video.

### CROSS-REFERENCES TO RELATED APPLICATIONS

This application is a national stage application of PCT Patent Application No. PCT/CN2015/093958, filed on Nov. 6, 2015, which claims priority to Chinese Patent Application No. 2015105385240, filed on Aug. 28, 2015, the content of all of which is incorporated herein by reference.

### FIELD OF THE INVENTION

The present invention relates to the field of consumer electronics, and, more particularly, to an interactive method on intelligent home appliance based on smart TV video scenes and the system thereof.

### BACKGROUND

In current technologies, when a user is watching a movie on TV, he has to keep staring at a plurality of video scenes shown on TV all the time, and the TV is usually playing the movie continuously, without any interaction, or any consideration on the user's real feeling, therefore, it is impossible to make the user immersing into the sense personally. A traditional method of playing a video on TV has a plurality of the following defects:

There is little communication or interaction between the user and the TV, the user can only watch what is shown on TV, while his surrounding environment can't change following the change of season or weather in the scene, also, a TV has no way to interact with a plurality of surrounding intellectual appliances, corresponding to the scenes playing on TV.

Therefore, the current technology needs to be improved and developed.

### BRIEF SUMMARY OF THE DISCLOSURE

According to the above described defects, the purpose of the present invention is providing an interactive method on intelligent home appliances based on smart TV video scenes and the system thereof, in order to solve the problem in the prior art that, the intelligent home appliances around a user can't change following a plurality of changes of TV scenes, there is no effective interactions between the intelligent TV and the intelligent home appliances, and there is no way for a user to realize the data on TV scene at home.

In order to achieve the above mentioned goals, the technical solution of the present invention to solve the technical problems is as follows:

An interactive method on intelligent home appliance based on smart TV video scene, wherein, the method comprises:

presetting a database to store a plurality of image features on different video scenes and an operation data on intelligent home appliance corresponding to a plurality of different video scene types;

obtaining a plurality of video data currently playing on the smart TV, extracting an image feature from the current video data through image recognition technology, and comparing with that saved in the database, to determine the current video scene type;

inquiring the operation data of the intelligent home appliance corresponding to the pre-stored video scene types based on the current video scene type, before connecting to the intelligent home appliance, followed by checking whether the connection between the smart TV and the intelligent home appliance is successful or not;

controlling the intelligent home appliance to perform the pre-stored corresponding operations, if the connection between the smart TV and the intelligent home appliance is detected to be successful.

The interactive method on intelligent home appliance based on smart TV video scene, wherein, the step of obtaining the video data currently playing on the smart TV, extracting an image feature from the current video data by image recognition, and comparing with that saved in the database, to decide the current video scene type, further comprises:

obtaining the video data playing on the smart TV, and real-time extracting a frame image from the video data;

performing a noise reduction process to the extracted frame image;

extracting and saving an image feature from the image after noise-reduction;

comparing the image feature of the saved frame image to that of the video scenes pre-stored in the database, before determining the current video scene type.

The interactive method on intelligent home appliance based on smart TV video scene, wherein, the step of inquiring the operation data of the intelligent home appliance corresponding to the pre-stored video scene types, before connecting to the intelligent home appliance, followed by checking whether the connection between the smart TV and the intelligent home appliance success or not, further comprises:

inquiring the operation data of the intelligent home appliance corresponding to the pre-stored video scene types, based on the current video scene type, before obtaining the operation to be performed and the intelligent home appliance to operate;

transmitting a control-instruction for wireless connection to the intelligent home appliance;

detecting whether the connection between the smart TV and the intelligent home appliance is successful or not.

The interactive method on intelligent home appliance based on smart TV video scene, wherein, the wireless connection includes a WIFI connection, a Bluetooth connection, a 2.4G connection or a ZigBee connection.

The interactive method on intelligent home appliance based on smart TV video scene, wherein, the step of controlling the intelligent home appliance to perform the pre-stored corresponding operations, if the connection between the smart TV and the intelligent home appliance is detected to be successful, further comprises:

if the connection between the smart TV and the intelligent home appliance is detected to be successful, and the current intelligent home appliance to operate is connecting to the smart TV by the wireless connection method of WIFI;

the smart TV sends an id of the intelligent home appliance to a server, then the server looks for an ip according to the id of the intelligent home appliance;

the server sends a control-instruction to the specific intelligent home appliance.

The interactive method on intelligent home appliance based on smart TV video scene, wherein, the step of controlling the intelligent home appliance to perform the pre-stored accordance operations, if the connection between the smart TV and the intelligent home appliance is detected to be successful, further comprises:

if the connection between the smart TV and the intelligent home appliance is detected to be successful, and the current intelligent home appliance to operate is connecting to the smart TV by a wireless connection method of Bluetooth connection, 2.4G connection or ZigBee connection;

then the smart TV sends the control-instruction directly to the intelligent home appliance.

An interaction system of intelligent home appliance based on smart TV video scene, wherein, it comprises:

a preset and storage module, applied to presetting a database to store a plurality of image features on different video scenes and an operation data on intelligent home appliance corresponding to different video scene types;

an obtaining and determination module, applied to obtaining a plurality of video data currently playing on the smart TV, extracting an image feature in the current video data by image recognition technology, and comparing with that saved in the database to determine the current video scene type;

an inquiry and determination module, applied to inquiring the operation data of the intelligent home appliance corresponding to the pre-stored video scene types based on the current video scene type, before connecting to the intelligent home appliance, and followed by checking whether the connection between the smart TV and the intelligent home appliance is success or not;

a control module, applied to controlling the intelligent home appliance to perform the pre-stored corresponding operation, if the connection between the smart TV and the intelligent home appliance is detected to be successful.

The said interaction system of intelligent home appliance based on smart TV video scene, wherein, the said obtaining and determination module further includes:

an extraction unit, applied to obtaining the video data on play by the smart TV, and real-time extracting the frame images in the video data;

a noise reduction unit, applied to reducing the noise of the extracted frame images;

a feathers extraction and storage unit, applied to extracting the image features from the image after noise-reduction before saving;

a comparison and determination unit, applied to comparing the image features of the saved frame image to that of the video scenes pre-stored in the database, before determining the current video scene type.

The said interaction system of intelligent home appliance based on smart TV video scene, wherein, the said inquiry and determination module further includes:

an obtaining unit, applied to inquiring the operation data of the intelligent home appliance corresponding to the pre-stored video scene types based on the current video scene type, before obtaining the operations to perform and the intelligent home appliances to operate;

a control-instruction delivery unit, applied to delivering control-instructions for wireless connection to the intelligent home appliances;

a determination unit, applied to determining whether the connection between the smart TV and the intelligent home appliance is successful or not;

the said wireless connection includes a WIFI connection, a Bluetooth connection, a 2.4G connection or a ZigBee connection.

The said interaction system of intelligent home appliance based on smart TV video scene, wherein, the said control-instruction delivering unit includes:

a first determination unit, applied to determining if the connection between the smart TV and the intelligent home appliance is successful, and if the current intelligent home appliance to operate is connecting to the smart TV by the wireless connection method of WIFI;

a searching unit, applied to looking for an ip according to the id of the intelligent home appliance, after the smart TV sending the id of the intelligent home appliance to the server;

a first transmitting unit, applied for the server to transmitting the control-instructions to the specific intelligent home appliance;

a second determination unit, applied to determining if the connection between the smart TV and the intelligent home appliance is successful, and if the current intelligent home appliance to operate is connecting to the smart TV by the wireless connection method of Bluetooth connection, 2.4G connection or ZigBee connection;

a second transmitting unit, applied for the smart TV transmitting the control-instruction directly to the intelligent home appliance.

Benefits: the present invention may extract the image features for analysis from the video images by using the image recognition technology, through real-time extracting a plurality of scene elements of the video content playing on a TV, and determine a scene type of the video pictures, then, based on the scene types, control automatically a plurality of intelligent home appliances to perform the corresponding operations corresponding to the scene types, before changing a circumstance condition around a user, and achieving the same circumstance around the user as that of the video scenes currently playing on TV, finally making the intelligent home appliances be able to interact effectively corresponding to the content playing on the smart TV, and bringing convenience to users when watching a video.

### BRIEF DESCRIPTION OF THE DRAWINGS

FIG. 1 illustrates a flowchart of a preferred embodiment on the interactive method on intelligent home appliance based on smart TV video scene, as provided in the present invention;

FIG. 2 illustrates a schematic diagram corresponding to the scene information, functions and appliances of a specific embodiment on the interactive method on intelligent home appliance based on smart TV video scene, as provided in the present invention;

FIG. 3 illustrates a flowchart on extracting the video scene data of a preferred embodiment on the interactive method on intelligent home appliance based on smart TV video scene, as provided in the present invention;

FIG. 4 illustrates a flowchart on controlling the intelligent home appliances of a preferred embodiment on the interactive method on intelligent home appliances based on smart TV video scene, as provided in the present invention;

FIG. 5 illustrates a functional block diagram on a preferred embodiment of the interactive system of intelligent home appliances based on smart TV video scenes as provided in the present invention.

### DETAILED DESCRIPTION OF EMBODIMENTS

The present invention provides an interactive method on intelligent home appliance based on smart TV video scene, and the system thereof, in order to make the purpose, technical solution and the advantages of the present invention clearer and more explicit, further detailed descriptions of the present invention are stated here, referencing to the attached drawings and some preferred embodiments of the present invention. It should be understood that the detailed embodiments of the invention described here are used to explain the present invention only, instead of limiting the present invention.

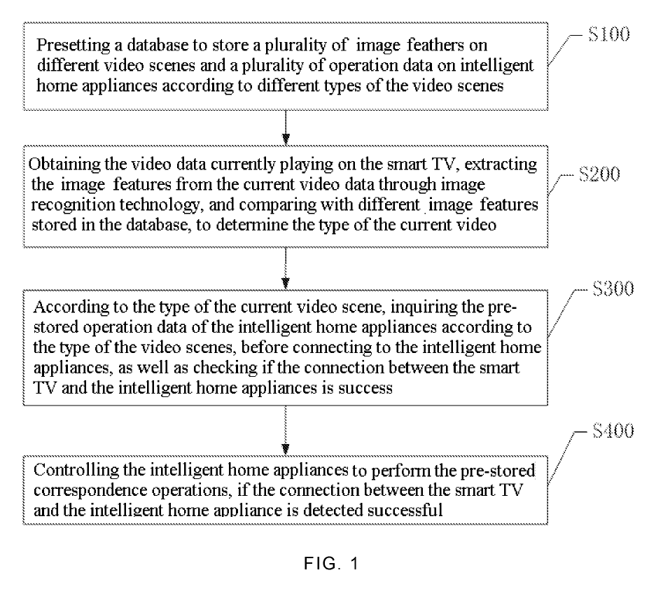

The present invention provides a flowchart of a preferred embodiment on the interactive method on intelligent home appliance based on smart TV video scene, shown as FIG. 1, wherein, the said method comprises:

step S100, presetting a database to store a plurality of image features on different video scenes and an operation data on intelligent home appliances corresponding to different video scene types.

In specific implementations, presetting a database, applied to storing image features on different video scene types, to facilitate the comparison with the later-obtained image features extracted from the video scenes played on the smart TV, and determining which type the current scene is. At the same time, operations for appliances to operate corresponding to different video scenes are also stored. Specifically, the database may be stored in the smart TV, may also be stored in a server connecting with the smart TV network. While the operation data of the intelligent home appliances corresponding to the scene types, for example, when the scene type is a winter, it is needed to control an AC or a fan blowing, as well as controlling the AC lowering a temperature.

step S200, obtaining a plurality of video data currently playing on the smart TV, extracting the image features from the current video data through image recognition technology, and comparing with different image features stored in the database, to determine the current video scene type.

In specific implementations, when it is detected that the smart TV currently is playing video data, the frame images of the video currently on play are real-time obtained through an image processing technology, the image features of the frame image are extracted through image recognition, and the specific image feature is compared with the image features stored in the database, then, the video scene type corresponding to the current video is obtained.

Specifically, the present invention further provides an application embodiment on an algorithm for images comparison, using a Perceptual hash algorithm to generate a string of “fingerprint” for each image, before comparing the fingerprints of different images. The closer the results are, the similar the images are. The method comprises:

step 1: reducing a size.

Shrinking the image into a size of 8×8, 64 pixels as a total, this may also be selected corresponding to real requirements. The purpose of the specific step is removing details of the image, while retaining the structures, brightness and other basic information only, so as to remove a plurality of differences between images due to different sizes or ratios.

Step 2, simplifying a plurality of colors.

The shrunk image is then converted into a 64-grade grayscale. In other words, all pixels have together 64 colors only.

Step 3, calculating an average.

A grayscale average of all 64 pixels is calculated.

Step 4, comparing the grayscales between pixels.

The grayscale of each pixel is compared with the average. If it is larger than or equal to the average, it is recorded as 1; if it is smaller than the average, it is recorded as 0.

Step 5, calculating a Hash value

The comparison results from the last step are combined together, and forming a 64-digit-integer, which composes a fingerprint of the specific image, while a sequence of the combination is not important, as long as all images are adopting the same sequence.

After obtaining the fingerprint, different images may be compared to check for a plurality of different digits among the 64 digits. Theoretically, this equals to calculating a “Hamming distance”. If a number of the different digits is less than 5, the two images are considered pretty similar; if the number of different digits is more than 10, then the two images are considered different. When two images are pretty similar, then the image in the current scene video is considered owning the same feathers as that of the pre-stored ones.

In practical implementations, usually, a more powerful pHash algorithm and SIFT algorithm may be adopted, which may recognize a deformation of the image. As long as the deformation is less than 25%, the original image may be matched. Although these algorithms are more complicated, their principle is as same as that of the above said simplified algorithms, that is, converting the image into a Hash string, before comparing.

Further, the said step S200 includes specifically:

Step S201, obtaining the video data currently playing on the smart TV, and extracting a frame image from the video data;

Step S202, executing a noise-reduction process to the extracted frame image;

Step S203, extracting the image features from the noise-reduced frame image through image recognition technology before saving;

Step S204, comparing the image features of the stored frame images with that of the pre-stored video scene images, and determining the type of the current video scene.

In specific implementations, it is mainly extracting the information from the video scenes, real-time extracting the current frame image before processing by the image recognition process, and obtaining the scene type information through image recognition technologies. The scene information mainly comprises the following information as shown in table 1:

| Seq. | 1 | 2 | 3 | 4 | 5 | 6 | . . . |
|---|---|---|---|---|---|---|---|
| Scene | Season | Time | Tempera- | Weath- | Geogra- | Event | . . . |
| types | info. | info. | ture info | er info. | phy info. | info. | |

Wherein, the season information: determining the current air qualities and more, the time information: determining the current air brightness and more, the temperature information: determining the current temperature and more, the weather information: determining if it is windy, raining or thundering and lightning, and more, the geography information: determining the current climate and more, the event information: such as vibration, tilt, driving speed and more.

Step S300, corresponding to the current video scene type, inquiring the pre-stored operation data of the intelligent home appliances corresponding to the video scene type, before connecting to the intelligent home appliances, as well as checking whether the connection between the smart TV and the intelligent home appliances is success or not.

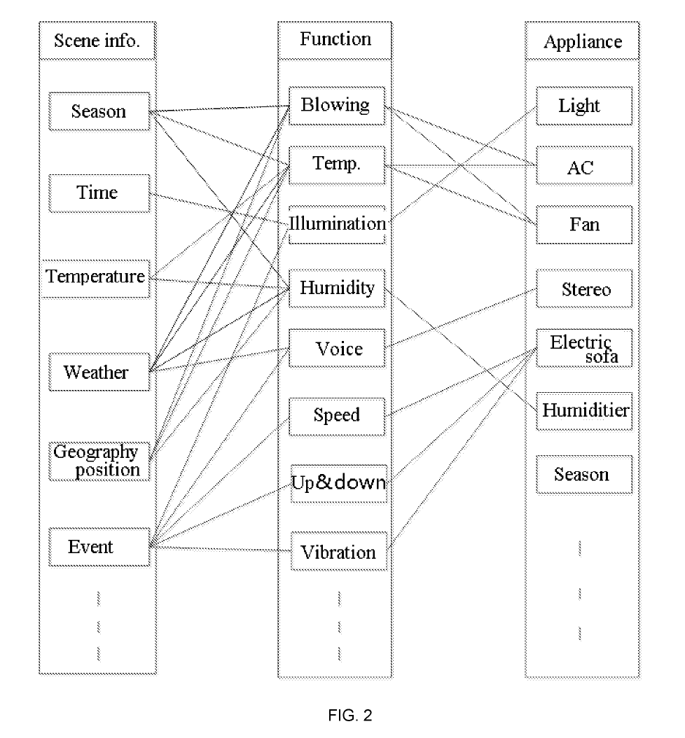

In specific implementations, it may determine the current scene corresponding to the extracted information, before determining different functions corresponding to the current scene, then, operating the corresponding appliances corresponding to the different functions. For example, if the current season is winter, then it is needed to control an AC to lower the temperature. A specific correspondence figure of the scenes, functions and appliances is shown in FIG. 2.

For example, the scene information is corresponding to the season of winter, then, the functions need to be adjusted include: blowing, temperature adjustment, humidity changing, while appliances corresponding to these functions are: an AC and a humidifier.

Further, the said step S300 comprises specifically:

step S301, corresponding to the current video scene type, inquiring the pre-stored operation data of the intelligent home appliances corresponding to that of the video scene type, and obtaining the operations to perform and the intelligent home appliances to operate;

step S302, delivering wireless connection control-instruction to the intelligent home appliance;

Step S303, checking whether the connection between the smart TV and the intelligent home appliance is success or not.

Wherein, the said wireless connection comprises a WIFI connection, a Bluetooth connection, a 2.4G connection or a Zigbee connection.

In specific implementations, for different appliances, the control methods are also different, there are Wifi devices, Bluetooth devices and other different devices connecting in different ways, including 2.4G and Zigbee, they may be controlled by directly pointed instructions.

Step S400, controlling the intelligent home appliances to perform the pre-stored correspondence operations.

In a further embodiment, in the said step S302, if the intelligent home appliance is connected with the smart TV in a wireless connection method of WIFI, then the step S400 includes specifically:

step S401, if it is detected that, the current intelligent home appliance for operation is connecting to the smart TV by a wireless connection method of WIFI;

step S402, the smart TV sends an id of the intelligent home appliance to a server, then the server searches for an ip according to the id of the intelligent home appliance;

step S403, the server sends a control-instruction to the specific intelligent home appliance.

In specific implementations, in the said step S302, if the intelligent home appliance is connected with the smart TV in a wireless connection method of Bluetooth, 2.4G or Zigbee, then the control method includes specifically:

step S411, if the current intelligent home appliances for operation are connecting to the smart TV by a wireless connection method of Bluetooth, 2.4G or Zigbee;

step S412, the smart TV delivers the control-instruction directly to the intelligent home appliances.

After the step S400, it further includes:

step S500, if a connection between the smart TV and the intelligent home appliances is detected failed, then, a piece of information on connection failure is prompt.

In specific implementations, when the connection between the smart TV and the intelligent home appliances is detected failed, that means, the user has not bought the specific intelligent home appliance, then, under a premise of not effecting watching, it may pop out a window on the smart TV screen to remind the user that, the current intelligent home appliance has not been bought. A specific position of the window may be selected at a center on the screen or left or right lower corner on the screen. Sizes of the window are smaller than 10 mm*10 mm. The window closes automatically if it has not detected any operations from the user in a preset time period, which is preferred to be between 10 and 30s, and may also be set corresponding to a user's requirement.

Further, the window may be set to link to a plurality of intelligent home appliance websites, and may provide a shopping entry for the intelligent home appliance for a user to click and enter a network on intelligent home appliance for shopping.

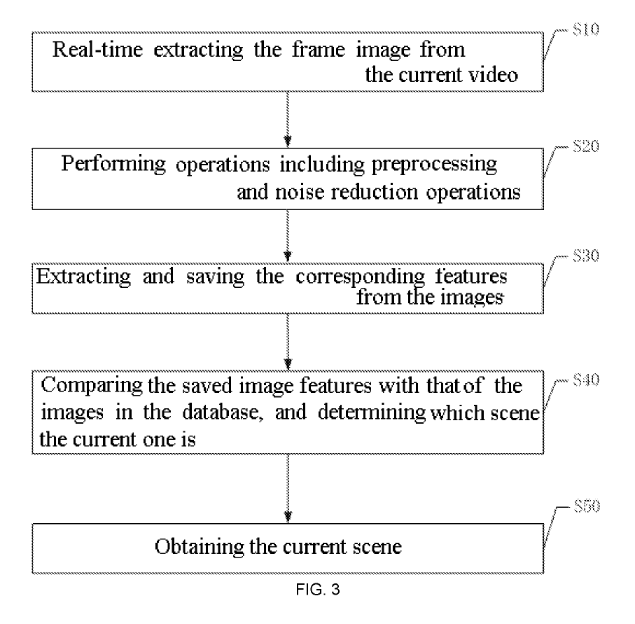

The present invention further provides an interactive method on intelligent home appliance based on smart TV video scenes, a flowchart on the method of extracting the video scene data of a specific embodiment is shown in FIG. 3, the said method includes:

step S10, real-time extracting the frame image from the current video;

step S20, executing a plurality of operations including preprocessing and noise reduction operations to the extracted images, in order to provide a correction rate to a plurality of following operations;

step S30, extracting and saving the corresponding features from the images;

step S40, comparing the saved image features with that of the images in the database, and determining which scene the current one is;

step S50, obtaining the current scene.

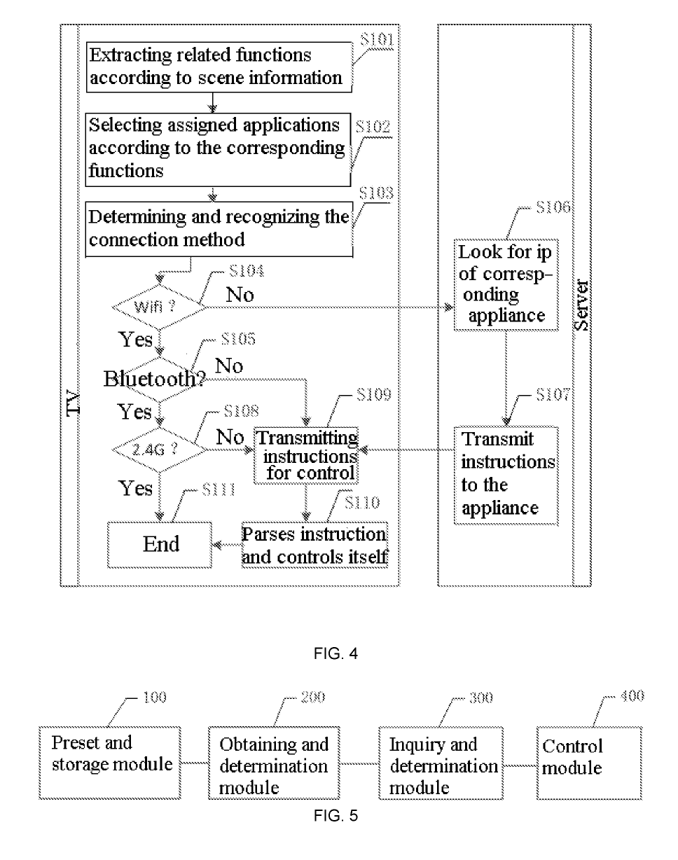

A flowchart on controlling the intelligent home appliances of a preferred embodiment on the interactive method on intelligent home appliance based on smart TV video scenes, as provided in the present invention, is shown in FIG. 4, the said method includes:

step S101, extracting related functions corresponding to the current scene information;

step S102, selecting the assigned applications corresponding to the corresponding functions;

step S103, determining and recognizing the connection method, that is, determining how these applications for operations will connect to the TV, and how to get controlled;

step S104, determining if they are accessed through wifi, if they are, then perform a step S106; if they are not, then perform a step S105;

step S105, determining if they are accessed through Bluetooth, if they are, then perform a step S109; if they are not, then perform a step S108;

step S106, transmitting the id of an appliance to the server, and the server will look for the ip according to the id of the appliance.

step S107, the server transmitting an instruction for control, and performing step S109;

step S108, determining if the application is accessed through 2.4G, if it is, then perform a step S109; if it is not, perform a step S111;

step S109, transmitting instructions for control to the appliance.

step S110, the appliance parses the instruction and controls itself;

step S111, operation ends.

It can be seen from the above listed embodiments that, the present invention has provided an interactive method on intelligent home appliance based on smart TV video scenes, through real-time extracting the image feature information from the video scenes current playing on the smart TV, and comparing with that of the pre-stored scene types, before obtaining the current scene type, then determining the intelligent home appliances to operate corresponding to the current scene type, based on different connection methods between the smart TV and the intelligent home appliances to operate, adopting different delivery methods for control-instructions, to achieve controlling the intelligent home appliances. The smart TV in the present invention may recognize intelligently the current playing video information, and control the intelligent home appliances corresponding to the video information, which makes the user feel the same scene information as that in the video, and improves the interaction between the smart TV and the intelligent home appliances, thus bringing convenience to users when watching a video.

Based on the above said embodiments for the method, the present invention further provides an interactive system on intelligent home appliance based on smart TV video scenes, a functional block diagram on a preferred embodiment of the said interactive system is shown as FIG. 5, wherein, the said system comprises:

a preset and storage module 100, applied to presetting a database to store a plurality of image features on different video scenes and an operation data on intelligent home appliances corresponding to different video scene types; details have been stated above.

an obtaining and determination module 200, applied to obtaining a plurality of video data currently playing on the smart TV, extracting the image features from the current video data by image recognition technology, and comparing with different image features stored in the database, to determine the current video scene type; details have been stated above.

an inquiry and determination module 300, applied to inquiring the pre-stored operation data of the intelligent home appliances corresponding to the video scene type, before connecting to the intelligent home appliances, as well as checking whether the connection between the smart TV and the intelligent home appliances is successful or not, corresponding to the current video scene type;

details have been stated above.

a control module 400, applied to controlling the intelligent home appliance to perform the pre-stored accordance operations, if the connection between the smart TV and the intelligent home appliance is detected to be successful; details have been stated above.

In an embodiment, the said obtaining and determination module further includes:

an extraction unit, applied to obtaining the video data on play by the smart TV, and real-time extracting the frame images in the video data; details have been stated above.

a noise reduction unit, applied to reducing the noise of the extracted frame images; details have been stated above.

a feathers extraction and storage unit, applied to extracting the image features from the image after noise-reduction before saving; details have been stated above.

a comparison and determination unit, applied to comparing the image features of the saved frame image to that of the video scenes pre-stored in the database, before determining the current video scene type; details have been stated above.

In specific implementations, the said inquiry and determination module further includes:

an obtaining unit, applied to inquiring the operation data of the intelligent home appliance corresponding to the pre-stored video scene types based on the current video scene type, before obtaining the operations to perform and the intelligent home appliances for operation; details have been stated above.

a control-instructions delivery unit, applied to delivering control-instructions for wireless connection to the intelligent home appliances; details have been stated above.

a determination unit, applied to determining whether the connection between the smart TV and the intelligent home appliance is successful or not; details have been stated above.

the said wireless connection includes WIFI connection, Bluetooth connection, 2.4G connection or ZigBee connection; details have been stated above.

Further, the said control-instructions delivering unit includes:

a first determination unit, applied to determining if the connection between the smart TV and the intelligent home appliance is detected to be successful, and if the current intelligent home appliance for operation is connecting to the smart TV by the wireless connection method of WIFI; details have been stated above.

a searching unit, applied to searching for an ip according to the id of the intelligent home appliance, after the smart TV sending the id of the intelligent home appliance to the server; details have been stated above.

a first delivery unit, applied for the server to delivering the control-instructions to the specific intelligent home appliance; details have been stated above.

a second determination unit, applied to determining if the connection between the smart TV and the intelligent home appliance is detected to be successful, and the current intelligent home appliance for operation is connecting to the smart TV by the wireless connection method of Bluetooth connection, 2.4G connection or ZigBee connection; details have been stated above.

a second delivery unit, applied for the smart TV to delivering the control-instruction directly to the intelligent home appliance; details have been stated above.

All above, the present invention has provided an interactive method on intelligent home appliance based on smart TV video scenes and the system thereof, wherein, the said method includes: presetting a database to store a plurality of image features on different video scenes and an operation data on intelligent home appliance corresponding to different video scene types; obtaining a plurality of video data currently playing on the smart TV, and determining the current video scene type; based on the current video scene type, starting connection with the intelligent home appliances, and checking whether the connection between the smart TV and the intelligent home appliance is success or not; if the connection between the smart TV and the intelligent home appliance is detected to be successful, then the intelligent home appliances are controlled to perform the corresponding operations. The present invention may analyze the scene elements of the video contents playing on TV, and control various intelligent home appliances to automatically change the surrounding environment conditions of the user, thus may make the user immersive, and improve the interaction between the smart TV and intelligent home appliances, which has facilitated a user to watch a video.

It should be understood that, the application of the present invention is not limited to the above examples listed. Ordinary technical personnel in this field can improve or change the applications according to the above descriptions, all of these improvements and transforms should belong to the scope of protection in the appended claims of the present invention.

What is claimed is:

1. An interactive method on intelligent home appliance based on smart TV video scenes, wherein, the method comprises:
presetting a database to store a plurality of image features on different video scenes and an operation data on intelligent home appliance corresponding to a plurality of different video scene types ;
obtaining a plurality of video data currently playing on the smart TV, extracting an image feature from the current video data through image recognition technology, and comparing with that saved in the database, to determine the current video scene type;
inquiring the operation data of the intelligent home appliance corresponding to the pre-stored video scene types based on the current video scene type, before connecting to the intelligent home appliance, followed by checking whether the connection between the smart TV and the intelligent home appliance is successful or not;
controlling the intelligent home appliance to perform the pre-stored corresponding operations, if the connection between the smart TV and the intelligent home appliance is detected to be successful.

2. The interactive method on intelligent home appliance based on smart TV video scenes according to claim 1, wherein, the step of obtaining the video data currently playing on the smart TV, extracting an image feature from the current video data by image recognition, and comparing with that saved in the database, to decide the current video scene type, further comprises:
obtaining the video data playing on the smart TV, and real-time extracting a frame image from the video data;
performing a noise reduction process to the extracted frame image;
extracting and saving an image feather from the frame image after noise-reduction;
comparing the image feature of the saved frame image to that of the video scenes pre-stored in the database, before determining the current video scene type.

3. An interactive method on intelligent home appliance based on smart TV video scene, wherein, the method comprises:
presetting a database to store a plurality of image features on different video scenes and an operation data on intelligent home appliance corresponding to a plurality of different video scene types;
obtaining a plurality of video data currently playing on the smart TV, extracting an image feature from the current video data through image recognition technology, and comparing with that saved in the database, to determine the current video scene type;
inquiring the operation data of the intelligent home appliance corresponding to the pre-stored video scene types based on the current video scene type, before connecting to the intelligent home appliance, followed by checking whether the connection between the smart TV and the intelligent home appliance is successful or not;
controlling the intelligent home appliance to perform the pre-stored corresponding operations, if the connection between the smart TV and the intelligent home appliance is detected to be successful.
the step of inquiring the operation data of the intelligent home appliance corresponding to the pre-stored video scene types, before connecting to the intelligent home appliance, followed by checking whether the connection between the smart TV and the intelligent home appliance success or not, further comprises:
inquiring the operation data of the intelligent home appliance corresponding to the pre-stored video scene types, based on the current video scene type, before obtaining an operation to be performed and the intelligent home appliance for operation;
transmitting a control-instruction for wireless connection to the intelligent home appliance;
detecting whether the connection between the smart TV and the intelligent home appliance is successful or not.

4. The interactive method on intelligent home appliance based on smart TV video scenes according to claim 3, wherein, the wireless connection includes a WIFI connection, a Bluetooth connection, a 2.4G connection or a ZigBee connection.

5. The interactive method on intelligent home appliance based on smart TV video scenes according to claim 3, wherein, the step of controlling the intelligent home appliance to perform the pre-stored corresponding operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by the wireless connection method of WI F I;
the smart TV sends an id of the intelligent home appliance to a server, then the server looks for an ip according to the id of the intelligent home appliance;
the server sends a control-instruction to the specific intelligent home appliance.

6. The interactive method on intelligent home appliance based on smart TV video scenes according to claim 3, wherein, the step of controlling the intelligent home appliance to perform the pre-stored accordance operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by a wireless connection method of Bluetooth connection, 2.4G connection or ZigBee connection;
then the smart TV sends the control-instruction directly to the intelligent home appliance.

7. The interactive method on intelligent home appliance based on smart TV video scenes according to claim 4, wherein, the step of controlling the intelligent home appliance to perform the pre-stored corresponding operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by the wireless connection method of WIFI;
the smart TV sends an id of the intelligent home appliance to a server, then the server looks for an ip according to the id of the intelligent home appliance;
the server sends a control-instruction to the specific intelligent home appliance.

8. The interactive method on intelligent home appliance based on smart TV video scenes according to claim 7, wherein, the step of controlling the intelligent home appliance to perform the pre-stored accordance operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by a wireless connection method of Bluetooth connection, 2.4G connection or ZigBee connection;
then the smart TV sends the control-instruction directly to the intelligent home appliance.

9. The interactive method on intelligent home appliance based on smart TV video scenes according to claim 4, wherein, the step of controlling the intelligent home appliance to perform the pre-stored accordance operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by a wireless connection method of Bluetooth connection, 2.4G connection or ZigBee connection;
then the smart TV sends the control-instruction directly to the intelligent home appliance.

10. The interactive method on intelligent home appliance based on smart TV video scenes according to claim 5, wherein, the step of controlling the intelligent home appliance to perform the pre-stored accordance operations, if the connection between the smart TV and the intelligent home appliance is detected to be successful, further comprises:
if the connection between the smart TV and the intelligent home appliance is detected to be successful, and the current intelligent home appliance for operation is connecting to the smart TV by a wireless connection method of Bluetooth connection, 2.4G connection or ZigBee connection;
then the smart TV sends the control-instruction directly to the intelligent home appliance.

11. The interactive method on intelligent home appliance based on smart TV video scenes according to claim 3, wherein, the step of obtaining the video data currently playing on the smart TV, extracting an image feature from the current video data by image recognition, and comparing with that saved in the database, to decide the current video scene type, further comprises:
obtaining the video data playing on the smart TV, and real-time extracting a frame image from the video data;
performing a noise reduction process to the extracted frame image;
extracting and saving an image feature from the image after noise-reduction;
comparing the image feature of the saved frame image to that of the video scenes pre-stored in the database, before determining the current video scene type.

12. An interaction system of intelligent home appliance based on smart TV video scenes, wherein, it comprises:
a preset and storage module, applied to presetting a database to store a plurality of image features on different video scenes and an operation data on intelligent home appliance corresponding to different video scene types;
an obtaining and determination module, applied to obtaining a plurality of video data currently playing on the smart TV, extracting an image feature in the current video data by image recognition technology, and comparing with that saved in the database to determine the current video scene type;
an inquiry and determination module, applied to inquiring the operation data of the intelligent home appliance corresponding to the pre-stored video scene types based on the current video scene type, before connecting to the intelligent home appliance, and followed by checking whether the connection between the smart TV and the intelligent home appliance is success or not;
a control module, applied to controlling the intelligent home appliance to perform the pre-stored corresponding operation, if the connection between the smart TV and the intelligent home appliance is detected to be successful.

13. The interaction system of intelligent home appliance based on smart TV video scene according to claim 12, wherein, the obtaining and determination module further includes:
an extraction unit, applied to obtaining the video data playing on the smart TV, and real-time extracting the frame images from the video data;
a noise reduction unit, applied to reducing the noise of the extracted frame images;
a feathers extraction and storage unit, applied to extracting and saving the image features from the image after noise-reduction;
a comparison and determination unit, applied to comparing the image features of the saved frame image to that of the video scenes pre-stored in the database, before determining the current video scene type.

14. The interaction system of intelligent home appliance based on smart TV video scenes according to claim 12, wherein, the inquiry and determination module further includes:
an obtaining unit, applied to inquiring the operation data of the intelligent home appliance corresponding to the pre-stored video scene types based on the current video scene type, before obtaining the operations to perform and the intelligent home appliances to operate;
a control-instruction delivery unit, applied to delivering control-instructions for wireless connection to the intelligent home appliances;
a determination unit, applied to determining whether the connection between the smart TV and the intelligent home appliance is successful or not;
the wireless connection includes a WIFI connection, a Bluetooth connection, a 2.4G connection or a ZigBee connection.

15. The interaction system of intelligent home appliance based on smart TV video scene according to claim 14, wherein, the control-instruction delivery unit includes:
a first determination unit, applied to determining if the connection between the smart TV and the intelligent home appliance is successful, and if the current intelligent home appliance to operate is connecting to the smart TV by the wireless connection method of WIFI;
a searching unit, applied to looking for an ip corresponding to the id of the intelligent home appliance, after the smart TV sending the id of the intelligent home appliance to the server;
a first transmitting unit, applied for the server to transmitting the control-instructions to the specific intelligent home appliance;
a second determination unit, applied to determining if the connection between the smart TV and the intelligent home appliance is successful, and if the current intelligent home appliance to operate is connecting to the smart TV by the wireless connection method of Bluetooth connection, 2.4G connection or ZigBee connection;
a second transmitting unit, applied for the smart TV transmitting the control-instruction directly to the intelligent home appliance.
